(19) United States
(12) Patent Application Publication
(10) Pub. No.: US 2002/0137513 A1
(43) Pub. Date: Sep. 26, 2002

(54) Communication terminal apparatus and radio communication method

(76) Inventors: Koichi Aihara, Kanagawa (JP); Kazuo Morimura, Kanagawa (JP); Hidetoshi Suzuki, Kanagawa (JP); Masatoshi Watanabe, Kanagawa (JP); Satoshi Imaizumi, Kanagawa (JP)

Correspondence Address: Stevens Davis Miller & Mosher, Suite 850, 1615 L Street NW, Washington, DC, 20036, US

(21) Appl. No.: 09/913,153

(22) PCT Filed: Dec. 5, 2000
(86) PCT No.: PCT/JP00/08604

(51) Int. Cl. H04Q 7/20; H04M 1/00; H04B 1/38

(52) U.S. Cl. 455/436; 455/441

(57) ABSTRACT

In a correlation circuit 103, a correlation value is obtained by despreading processing of a reception signal. The above correlation value is sent to a cell detection circuit 104 and a cell monitoring circuit 105. The above results of cell detection and cell monitoring are sent to a cell management table 106 for classification and management of cells. A management circuit 107 changes the cycle for cell monitoring/cell detection according to various kinds of events, and, then, gives an instruction for cell detection and cell monitoring at the changed cycle to the cell detection circuit 104 and the cell monitoring circuit 105.

### TECHNICAL FIELD

The present invention relates to a piece of communication terminal apparatus and a radio communication method in a digital radio communication system.

### BACKGROUND ART

A CDMA (Code Division Multiple Access) has been developed as a multi access scheme used for a next generation mobile communication method. In the above CDMA cellular system, a communication terminal performs cell detection and cell monitoring for cell switching (handover) during moving, and so on.

A method, by which detection of timing and the kind of a scrambling code is performed by masking of the scrambling code on a downlink control channel and by correlation detection of the masked section with a code for spreading common used to each cell, has been proposed as a cell detection method in the above CDMA cellular system, as disclosed in “High speed cell search method using a long code mask in an a synchronous cellular DS (Direct Spread)-CDMA between base stations” by HIGUCHI, SAWAHASHI, ADACHI, et al, IEICE (The Institute of Electronics, Information, and Communication Engineers) Technical Report RCS96-122, 1997-01.

In the above method, a transmission side (base station) transmits a symbol spread with the code for spreading common used to each cell; and a symbol spread with a short code for discrimination of a scrambling code group according to a scrambling code of each cell as a searching code after code multiplexing to a scrambling code masking section and a reception side (communication terminal) determines scrambling code candidates to be searched with a scrambling code identification section using the short code for discrimination of a scrambling code group after detection of a slot timing with the code for spreading common used to each cell; detects a frame timing; and further specifies a scrambling code peculiar to a cell from the above scrambling code candidates. Thereby, a new cell may be detected at high speed.

And, the above cell monitoring does not perform the above cell detection again, but carries out checking processing of the current levels (Ec/IO (signal electric power/transmitting and receiving electric power after despreading), and SIR (Signal to Interference Ratio), and so on) for base stations having a scrambling code and its rough frame timing both of which have been already clarified.

A conventional communication terminal has continuously performed cell detection and cell monitoring at a predetermined cycle. However, there are an increase in the electric power consumption for the communication terminal, and reduction in calling time and waiting time, when the communication terminal continuously performs cell detection and cell monitoring. On the other hand, when the frequencies for cell detection and cell monitoring are extremely reduced, no realtime and accurate cell management may be performed to cause failure in handover and a possibility that the calling is cut.

### DISCLOSURE OF INVENTION

The object of the present invention is to provide a piece of communication terminal apparatus and a radio communication method, which may save the electric power consumption as much as possible; and, moreover, may perform realtime and accurate cell management at cell detection and cell monitoring.

The subject of the present invention is dynamically to control and reduce the frequencies for cell detection and cell monitoring according to various kinds of factors (events); to save the electric power consumption as much as possible; and, moreover, to perform realtime and accurate cell management at cell detection and cell monitoring.

### BRIEF DESCRIPTION OF DRAWINGS

FIG. 1 is a block diagram showing a configuration of a piece of communication terminal apparatus according to an embodiment 1 of the present invention;

FIG. 2 is a view showing a cell management table according to a piece of communication terminal apparatus of the present invention;

FIG. 3 is a view showing a cell management table according to a piece of communication terminal apparatus of the present invention;

FIG. 4 is a view showing a cell management table according to a piece of communication terminal apparatus of the present invention;

FIG. 5 is a view showing a cell management table according to a piece of communication terminal apparatus of the present invention;

FIG. 6 is a block diagram showing a configuration of a piece of communication terminal apparatus according to an embodiment 2 of the present invention;

FIG. 7 is a block diagram showing a configuration of a piece of communication terminal apparatus according to an embodiment 3 of the present invention;

FIG. 8 is a block diagram showing a configuration of a piece of communication terminal apparatus according to an embodiment 4 of the present invention;

FIG. 9 is a block diagram showing a configuration of a piece of communication terminal apparatus according to an embodiment 5 of the present invention;

FIG. 10 is a block diagram showing a configuration of a piece of communication terminal apparatus according to an embodiment 6 of the present invention;

FIG. 11 is a block diagram showing a configuration of a piece of communication terminal apparatus according to an embodiment 7 of the present invention; and,

FIG. 12 is a block diagram showing a configuration of a piece of communication terminal apparatus according to an embodiment 8 of the present invention.

### BEST MODE FOR CARRYING OUT THE INVENTION

Hereinafter, embodiments according to the present invention will be described in detail, referring to the attached drawings.

Embodiment 1

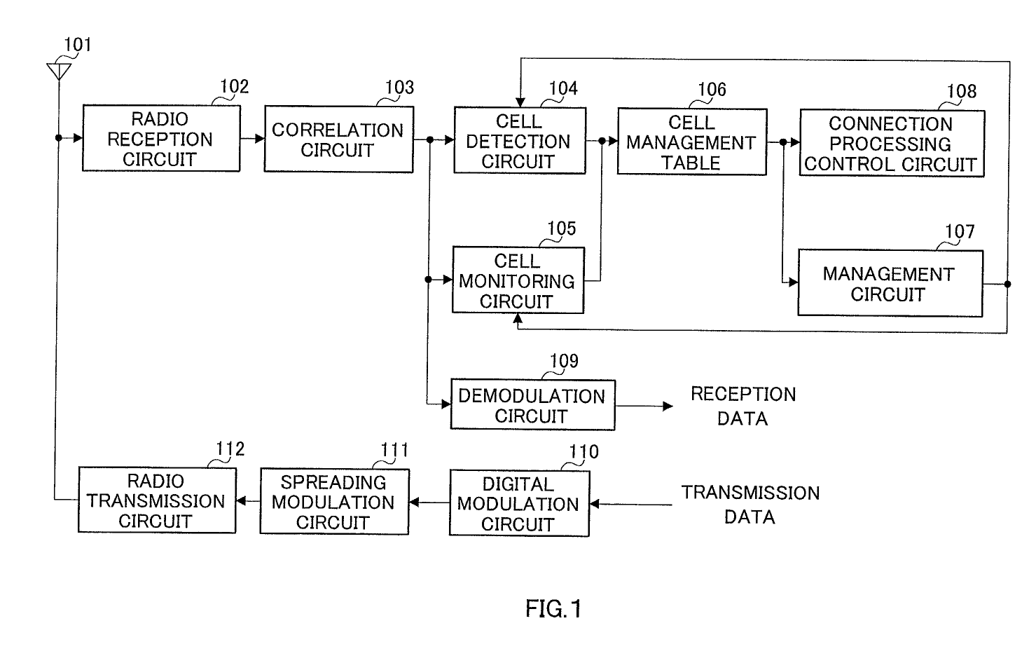

FIG. 1 is a block diagram showing a configuration of a piece of communication terminal apparatus according to an embodiment 1 of the present invention. There will be described below the cases, where a mode in a usual state, in which the cycle for cell detection/cell monitoring is set long, is switched to the following modes as required; a cell monitoring mode for reduction in the cell monitoring cycle; a cell detection mode for reduction in the cell detection cycle; and a cell monitoring/detection mode for reduction in the cycles for cell monitoring and cell detection. Here, the cycle which is set long means, for example, around 5 seconds, but the above cycle is not specially determined. As described above, cell monitoring and cell detection are performed at a long cycle in a usual state to cause efficient use of the electric power consumption.

In the above communication terminal apparatus, a signal transmitted from a piece of radio base station apparatus is received in a radio reception circuit 102 through an antenna 101. The above radio reception circuit 102 performs predetermined radio reception processing (for example, down convert, and analog/digital conversion) of the reception signal.

The reception signal after the radio reception processing as described above is output of a correlation circuit 103.

In the above correlation circuit 103, despreading processing of the reception signal is performed with a code for spreading (spreading code) used for spreading modulation at the transmission side to obtain a correlation value which is sent to a cell detection circuit 104.

In the above cell detection circuit 104, cell detection is performed using the correlation value obtained in the correlation circuit 103. And, the correlation value obtained in the correlation circuit 103 is also sent to a cell monitoring circuit 105. Further, the output from the correlation circuit 103 is sent to a demodulation circuit 109, where demodulation processing of the signal after the correlation processing is performed to obtain a reception data.

Cell detection results in the cell detection circuit 104 and cell monitoring results in the cell monitoring circuits 105 are sent to a cell management table 106 to update the cell management table 106 as required. In the above cell management table 106, base stations are classified for management into ones currently under communication (Active), candidate ones for a handover end (Candidate), or adjacent ones with a low level (Neighbor).

The information in the above cell management table 106 is sent to a connection processing control circuit 108 and at the same time to a management circuit 107. In the above connection processing control circuit 108, connection processing and so on at handover are controlled, based on the information in the cell management table (classification results).

And, the above management circuit 107 gives instructions for cell detection and cell monitoring, based on the information in the cell management table. That is, a control signal for cell detection is sent to the cell detection circuit 104, when the cell detection is required; and a control signal for cell monitoring is sent to the cell monitoring circuit 105, when the cell monitoring is required.

On the other hand, the transmission data is sent to a digital modulation circuit 110 for digital modulation, and then to a spreading modulation circuit 111, where spreading modulation processing of the signal after the digital modulation is performed, using a predetermined code for spreading, and the transmission data after the spreading modulation is sent to a radio transmission circuit 112, which performs predetermined radio transmission processing (digital/analog conversion, up convert and so on) of the transmission data after the spreading modulation. The transmission signal after radio transmission processing is transmitted to a base station through the antenna 101.

Then, control of the cycle for cell detection/cell monitoring of a piece of communication terminal apparatus with the above configuration will be described.

In the correlation circuit 103, despreading processing of the reception signal is performed to obtain a correlation value. The above correlation value is sent to the cell detection circuit 104 and the cell monitoring circuit 105. In the cell detection circuit 104, scrambling code candidates to be searched with a scrambling code identification section are determined, using a short code for discrimination of a scrambling code group after detection of a slot timing by a code for spreading common used to each cell; a frame timing is detected; and, further, cell detection processing for specification of a scrambling code peculiar to a cell from the above scrambling code candidates.

The above cell monitoring circuit 105 performs checking processing of the current levels (Ec/IO, and SIR, and so on) for base stations having a scrambling code and its rough frame timing both of which have been already clarified.

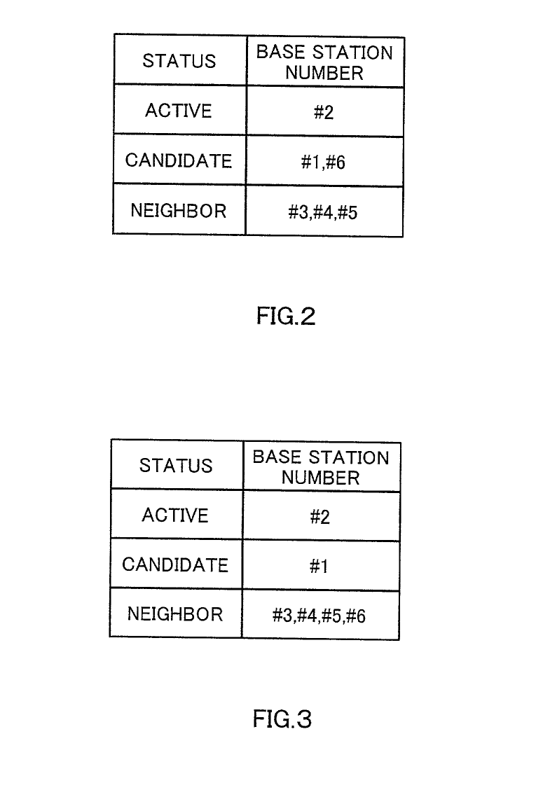

The above cell detection results and the cell monitoring ones are sent to the cell management table 106, and the cells are classified for management. For example, in the cell management table 106, base stations are classified for management, as shown in FIG. 2, into base stations currently under communication as a group of “ones currently under communication (Active)”, candidate base stations for a handover end as a group of “candidate ones for a handover end (Candidate)”, or base stations with a low level not as a candidate one for a handover end as a group of “adjacent ones with a low level (Neighbor)”.

That is, a base station #2 is currently under communication; base stations #1 and #6 are candidates for a handover end; base stations #3, #4, and #5 are the ones with a low level, that is, not candidates for a handover end, as understood from FIG. 2.

The management circuit 107 changes the cycles (frequencies) for cell detection and cell monitoring, based on the information in the cell management table 106, and the results in the cell detection circuit 104 and the cell monitoring circuit 105. Threshold judgment is performed according to levels and numbers of base stations divided, for example, into the following classifications. Specifically, the following methods are listed.

In the first place, as a first method, the cycle for cell monitoring is made shorter (the frequency is made higher.) for “candidate ones for a handover end (Candidate)”, or “adjacent ones with a low level (Neighbor), when the level of “ones currently under communication (Active)” is lower than a threshold, or when the sum of each level of “ones currently under communication” is lower than the threshold, for example, in the case of communication with a plurality of base stations such as at handover. In the description referring to FIG. 2, the cycles for cell monitoring of the base stations #1 and #6 in a group of “candidate ones as a handover end (Candidate)” are made shorter, when the level of the base station #2 in a group of “ones currently under communication (Active)” is lower than the threshold.

As described above, when the levels of base stations in a group of “ones currently under communication (Active)” are lower than the threshold, the levels of dominant waves of signals from base stations are assumed to be low, as the dominant waves of signals from base stations are hidden in the shadows of buildings and so on, or exist in the edge of each cell. In such a case, a handover end is configured to be selected early among “candidate ones as a handover end (Candidate)” by making the cycle shorter for cell monitoring of “Candidate ones as a handover end (Candidate)”. Thereby, quick response to handover may be realized and the communication quality may be secured.

As a second method, the cycles for cell monitoring of base stations in a group of “candidate ones as a handover end (Candidate)” or “adjacent ones with a low level (Neighbor)” are made shorter (the frequencies are made higher), when the number of base stations in a group of “ones currently under communication (Active)” is lower than a threshold. And, the cycles for cell monitoring of base stations in a group of “candidate ones as a handover end (Candidate)” or “adjacent ones with a low level (Neighbor)” are made longer (the frequencies are made lower), when the number of “ones currently under communication (Active)” is equal to or larger than the threshold.

Moreover, the cycles for cell monitoring and cell detection are made shorter as there is a possibility of failure in soft handover (diversity handover) due to small number of handover ends in the case of small number of “ones currently under communication (Active)”, when the number of “candidate ones as a hndover end (Candidate)” is less than a predetermined number, and/or when the number of “adjacent ones with a low level (Neighbor)” is less than a predetermined number.

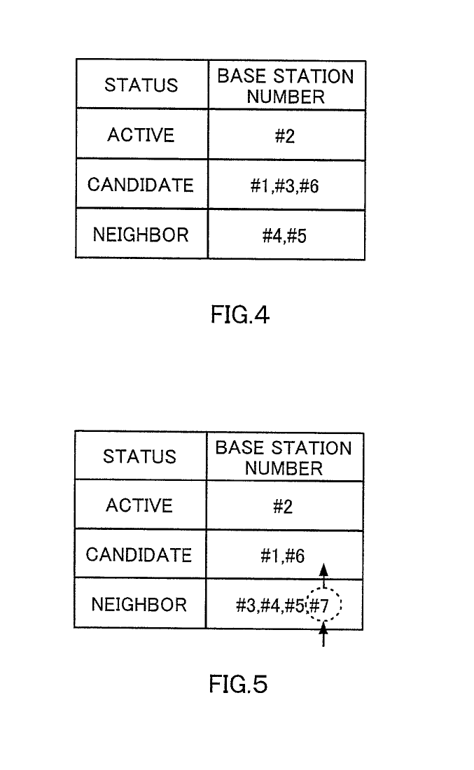

In the description referring to FIG. 3, “candidate ones as a handover end (Candidate)” are selected early, as shown in FIG. 4, by making the cycle for cell monitoring of “adjacent ones with a low level (Neighbor)” shorter, when only the base station #1 is in the group of “Candidate ones as a handover end (Candidate)”. Thereby, soft handover may be preferably realized.

As a third method, the cycle for cell detection is made shorter, when both the levels of “ones currently under communication (Active)” and “candidate ones as a handover end (Candidate)” are within a range of a threshold.

As described above, when both the levels of base stations in a group of “ones currently under communication (Active)” and in a group of “candidate ones as a handover end (Candidate)” are with in a range of a threshold, all of the levels of the dominant waves of signals from base stations in a group of “ones currently under communication (Active)” and in a group of “candidate ones as a handover end (Candidate)” are assumed to be low, as dominant waves of signals from base stations in a group of “ones currently under communication (Active)” and in a group of “candidate ones as a handover end (Candidate)” are hidden in the shadows of buildings and so on, or exist in the edge of each cell. In such a case, “ones currently under communication (Active)” and “candidate ones as a handover end (Candidate)” are configured to be selected early by making the cycle for cell detection shorter. Thereby, quick response to handover may be realized and the communication quality may be secured.

As a fourth method, the cycle for cell monitoring of a base station with a level which has become higher is made shorter, as it is assumed in such a case that the communication terminal is approaching to the above base station with a level which has become higher.

For example, the cycle for cell monitoring of a base station #7 is made shorter, as it is assumed that the communication terminal is approaching to the base station #7 when the base station #7 becomes included in a group of “adjacent ones with a low level (Neighbor)”, and, further, in a group of “candidate ones as a handover end (Candidate)” as shown in FIG. 5. Thereby, it is possible quickly to judge which base station has the highest possibility as a handover end.

As a fifth method, the cycle for cell monitoring of a base station is made shorter, as it is assumed that there is a high possibility that the communication terminal is in the cell edge of the above base station when the group in which the above base station is included is switched between “the level of ones currently under communication (Active)” and “the level of candidate ones as a handover end” many times in a predetermined time. Thereby, quick response to handover may be realized.

The management circuit 107 gives an instruction for cell monitoring/cell detection at a changed cycle to the cell detection circuit 104 and the cell monitoring circuit 105 after changing the cycle of the cell monitoring/cell detection by the above event.

Specifically, when the cycle for cell detection is made shorter, the mode of the management circuit 107 is switched from a normal mode (long cycles for cell detection and cell monitoring) to a cell detection mode, and a control signal for cell detection is sent to the cell detection circuit 104 at a short cycle for the cell detection mode. And, when the cycle of the cell monitoring is made shorter, the mode of the management circuit 107 is switched from a normal mode to a cell monitoring mode, and a control signal for cell monitoring at a short cycle for the cell monitoring mode is sent to the cell monitoring circuit 105. Further, when the cycles for cell detection and cell monitoring are made shorter, the mode of the management circuit 107 is switched from a normal mode to a cell detection/cell monitoring mode, and a control signal for cell detection at a short cycle for the cell detection/cell monitoring mode is sent to the cell detection circuit 104 and a control signal for cell monitoring at the above short cycle is done to the cell monitoring circuit 105.

As described above, it is possible to save the electric power consumption as much as possible; and, to make the calling time and waiting time longer, as a piece of communication terminal apparatus according to the present embodiment dynamically controls and reduces the frequencies for cell detection and cell monitoring, depending on the levels and the numbers of “ones currently under communication (Active)” and “candidate ones as a handover end (Candidate)”. And, the communication quality may be secured at handover by reliable handover, as it is possible to perform realtime and accurate cell management at cell detection and cell monitoring.

In the description of the present embodiment, base stations are classified to three groups of “ones currently under communication (Active)”, “candidate ones as a handover end (Candidate)” and “adjacent ones with a low level (Neighbor)”, but the base stations may be classified to two groups, or to equal to or more than four groups by changing a set threshold in the present invention.

Embodiment 2

In the description of the present embodiment, an average and/or a variance of each Ec/IO of fingers are monitored, and cycles for cell monitoring and cell detection are made shorter, regarding the time, when the above value or values becomes or become lower than the threshold, as an event.

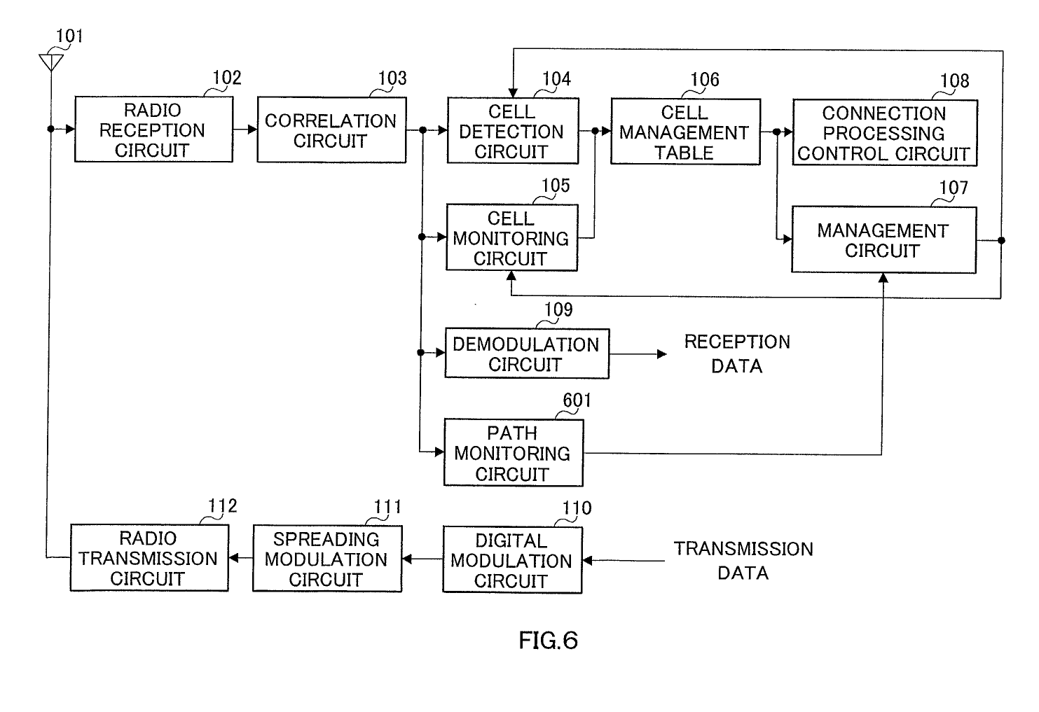

FIG. 6 is a block diagram showing a configuration of a piece of communication terminal apparatus according to an embodiment 2 of the present invention. In FIG. 6, parts similar to those in FIG. 1 are denoted by the same reference numerals as those in FIG. 1, and detailed description will be eliminated.

The communication terminal apparatus shown in FIG. 6 is provided with a path monitoring circuit 601 monitoring of paths for each finger, using the output of the correlation circuit 103. The above path monitoring circuit 601 sends an instruction for changing of the cycle for cell detection/cell monitoring, based on the path monitoring results. The management circuit 107 sends a control signal for cell detection/cell monitoring to the cell detection circuit 104 and/or the cell monitoring circuit 105 at the changed cycle.

Thereby, cell detection/cell monitoring is performed at the changed cycle.

Subsequently, control of the cycle for cell detection/cell monitoring of a piece of communication terminal apparatus with the above configuration will be described.

In the correlation circuit 103, a correlation value is obtained after despreading processing of a reception signal. The above correlation value is sent to the cell detection circuit 104 and the cell monitoring circuit 105, and, at the same time, to the path monitoring circuit 601.

In the cell detection circuit 104 and the cell monitoring circuit 105, cell detection and cell monitoring are performed, based on the correlation value for sending the results to the cell management table 106. In the cell management table 106, a classification, for example, to base stations currently under communication in a group of “ones currently under communication (Active)”; base stations as candidate ones as a handover end in a group of “candidate ones as a handover end (Candidate)”; or base stations with a low level which is not a candidate as a handover end in a group of “adjacent ones with a low level (Neighbor)” is performed for management. Here, cell detection and cell monitoring are performed in a similar manner to those of the embodiment 1.

The path monitoring circuit 601 performs path monitoring for each finger based on the correlated values. Specifically, the path monitoring circuit 601 obtains each Ec/IO of fingers for monitoring its averages and variances. And, when the averages and the variances are lower than a predetermined threshold, a control signal for making the cycles for cell monitoring and cell detection shorter is sent to the management circuit 107, assuming that there are no dominant waves of signals from base stations. The management circuit 107 changes the cycles for cell detection and cell monitoring according to the control signal, and gives an instruction for cell detection and cell monitoring at the changed cycles to the cell detection circuit 104 and the cell monitoring circuit 105.

As described above, it is possible in the communication terminal apparatus according to the present embodiment to save the electric power consumption as much as possible; and, to make the calling time and waiting time longer by dynamic control of the frequencies for cell detection and cell monitoring according to each Ec/IO of fingers. And, handover operation may be performed in a reliable manner, and the communication quality may be secured at handover, as it is possible to perform realtime and accurate cell management at cell detection and cell monitoring.

Here, though control of the cycles for cell detection and cell monitoring is performed according to the averages and the variances for each Ec/IO in the description of the present embodiment, the reception quality other than the Ec/IO of each finger may be monitored and the cycles for cell detection and cell monitoring may be controlled based on the monitoring results in the present invention.

Embodiment 3

In the description of the present embodiment, a rapid change in the reception level is monitored, and cycles for cell monitoring and cell detection are made shorter, regarding the rapid change in the reception level as an event.

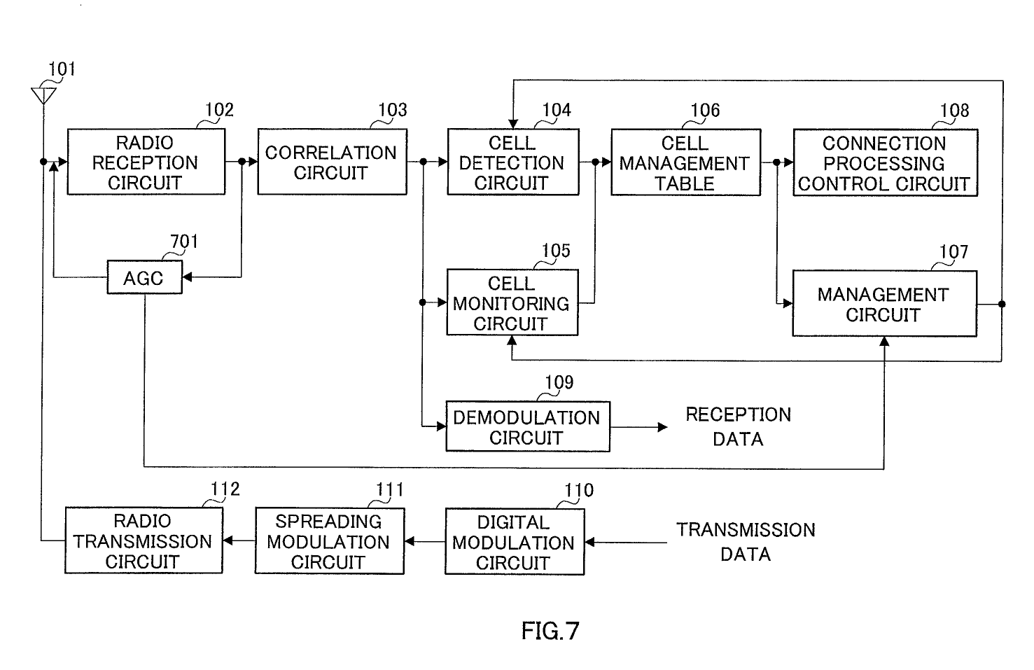

FIG. 7 is a block diagram showing a configuration of a piece of communication terminal apparatus according to an embodiment 3 of the present invention. In FIG. 7, parts similar to those in FIG. 1 are denoted by the same reference numerals as those in FIG. 1, and detailed description will be eliminated.

The communication terminal apparatus shown in FIG. 7 is provided with an AGC circuit 701 for output of a gain-controlled signal to the radio reception circuit 102 after gain control of the output of the radio reception circuit 102. The above AGC circuit 701 monitors the output of the radio reception circuit 102, and sends an instruction for changing, based on the monitoring results, the cycle for cell detection/cell monitoring to the management circuit 107. The management circuit 107 sends a control signal for cell detection/cell monitoring at the changed cycle to the cell detection circuit 104 and/or the cell monitoring circuit 105. Thereby, cell detection/cell monitoring is performed at the changed cycle.

Then, control of the cycle for cell detection/cell monitoring of a piece of communication terminal apparatus with the above configuration will be described.

Predetermined radio reception processing of a reception signal received with the radio reception circuit 102 through the antenna 101 is performed with the radio reception circuit 102. The signal after the above radio reception processing is output from the radio reception circuit 102 to the AGC circuit 701 for gain control with the AGC circuit 701. In such a case, the AGC circuit 701 monitors a rapid change in the reception level, too. And the AGC circuit 701 sends a control signal for making the cycles for cell monitoring and cell detection shorter to the management circuit 107 in the case of a rapid change in the reception level change, for example, when a base station suddenly appears from the shadow of a building, and when a call on a high speed user data channel is disconnected. The management circuit 107 changes the cycles for cell detection and cell monitoring according to the above control signal, and gives instructions for cell detection and cell monitoring at the changed cycles to the cell detection circuit 104 and the cell monitoring circuit 105. Here, the above rapid change in the reception level may be detected by the threshold judgement, for example, of a variation from the previous measurement.

The signal after gain control with the AGC circuit 701 is sent to the radio reception circuit 102 for predetermined radio reception processing, and then to the correlation circuit 103. In the correlation circuit 103, despreading processing of the reception signal is performed to obtain a correlation value, which is sent to the cell detection circuit 104 and the cell monitoring circuit 105. The processing in the cell detection circuit 104 and the cell monitoring circuit 105 is performed in a similar manner to those of the above embodiment, and the description will be eliminated. Here, cell detection and cell monitoring are performed in a similar manner to those of the embodiment 1.

As described above, the communication terminal apparatus according to the present embodiment saves electric power consumption as much as possible; and, makes calling time and waiting time longer by dynamic control of the frequencies for cell detection and cell monitoring according to a rapid change in the reception level. And, handover operation may be performed in a reliable manner, and the communication quality may be secured at handover, as it is possible to perform realtime and accurate cell management at cell detection and cell monitoring.

Embodiment 4

In the description of the present embodiment, a moving speed and an altitude are monitored and cycles for cell monitoring and cell detection are controlled, regarding moving speed and altitude as an event.

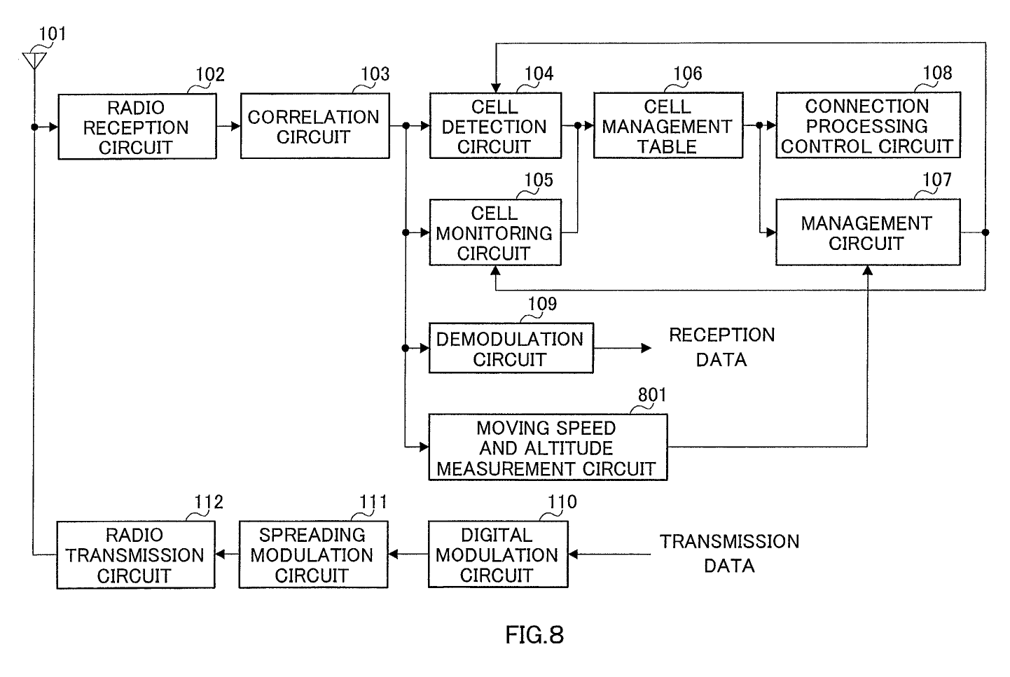

FIG. 8 is a block diagram showing a configuration of a piece of communication terminal apparatus according to an embodiment 4 of the present invention. In FIG. 8, parts similar to those in FIG. 1 are denoted by the same reference numerals as those in FIG. 1, and detailed description will be eliminated.

The communication terminal apparatus shown in FIG. 8 is provided with a moving speed/altitude measurement circuit 801 for measurement of moving speed and altitude using the output of the correlation circuit 103. The above moving speed and altitude measurement circuit 801 obtains moving speed, using the Doppler frequency, or moving speed and altitude using a positioning system. And an instruction for changing the cycle for cell detection/cell monitoring based on the above moving speed and the altitude is sent to the management circuit 107. The management circuit 107 sends a control signal for cell detection/cell monitoring at the changed cycle to the cell detection 104 and/or the cell monitoring 105. Thereby, cell detection/cell monitoring is performed at the changed cycle.

Subsequently, control of the cycle for cell detection/cell monitoring of a piece of communication terminal apparatus with the above configuration will be described.

In the correlation circuit 103, a correlation value is obtained after despreading processing of the reception signal. The above correlation value is sent to the cell detection circuit 104 and the cell monitoring circuit 105, and at the same time to the moving speed/altitude measurement circuit 801.

In the moving speed and altitude measurement circuit 801, the moving speed and the altitude are measured, and a control signal for changing the cycles for cell detection and cell monitoring, for example, when the above measured value exceeds a predetermined threshold. The management circuit 107 changes the cycles for cell detection and cell monitoring according to the above control signal, and gives instructions for cell detection and cell monitoring according to the changed cycles to the cell detection circuit 104 and the cell monitoring circuit 105. For example, the cycles for cell detection and cell monitoring are made shorter, as it is assumed that there is a high possibility of handover when moving speed is high (when the Doppler frequency is high). And, the cycles for cell detection and cell monitoring are made longer in the case of the high altitude, as it is assumed that there is less signal reflection.

The processing in the cell detection circuit 104 and the cell monitoring circuit 105 is performed in a similar manner to those of the above embodiment, and the description will be eliminated. Here, cell detection and cell monitoring are performed in a similar manner to those of the embodiment 1.

As described above, the communication terminal apparatus according to the present embodiment saves electric power consumption as much as possible; and, makes calling time and waiting time longer by dynamic control of the frequencies for cell detection and cell monitoring according to the moving speed and the altitude. And, handover operation may be performed in a reliable manner, and the communication quality may be secured at handover, as it is possible to perform realtime and accurate cell management at cell detection and cell monitoring.

Embodiment 5

In the description of the present embodiment, cycles for cell monitoring and cell detection are controlled, regarding information on the external electric power as an event.

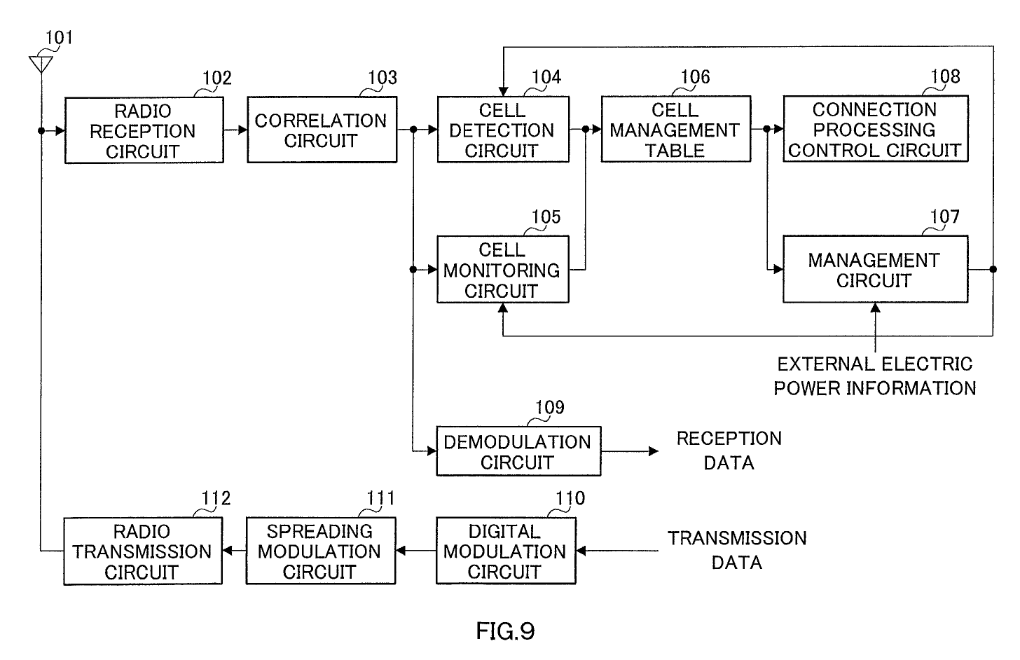

FIG. 9 is a block diagram showing a configuration of a piece of communication terminal apparatus according to an embodiment 5 of the present invention. In FIG. 9, parts similar to those in FIG. 1 are denoted by the same reference numerals as those in FIG. 1, and detailed description will be eliminated.

The communication terminal apparatus shown in FIG. 9 has a configuration where the external electric power information is input to the management circuit 107, in which a control signal for cell detection/cell monitoring is sent to the cell detection circuit 104 and/or the cell monitoring circuit 105 according to the above external electric power information. Thereby, the cell detection and the cell monitoring are performed at the changed cycle.

As the external electric power information, the following ones may be listed, for example: information connected to an on-board kit; information connected to an AC charger; and information connected to a personal computer. That is, when the management circuit 107 receives information for identification of pieces of built-in apparatus such as an on-board kit, cycles for cell detection and cell monitoring are made shorter, as it is assumed that there is a high possibility of high speed movement and handover. And, the cycles for cell detection and cell monitoring are made longer for energy conversation and increase in the charging rate, when the management circuit 107 receives information for identification of the charger. Further, the cycles for cell detection and cell monitoring are made shorter as there is no need to consider the electric power consumption when information for identification of a piece of external electric power apparatus of a piece of fixed type apparatus such as a personal computer is received. However, the cycles for cell detection and cell monitoring are made longer, when a battery in the own apparatus is used even in the case of connection to a personal computer.

The processing in the cell detection circuit 104 and the cell monitoring circuit 105 is performed in a similar manner to those of the above embodiment, and the description will be eliminated. Here, cell detection and cell monitoring are performed in a similar manner to those of the embodiment 1.

As described above, the communication terminal apparatus according to the present embodiment saves electric power consumption as much as possible; and, makes calling time and waiting time longer by dynamic control of the frequencies for cell detection and cell monitoring according to the information on the external electric power. And, handover operation may be performed in a reliable manner, and the communication quality may be secured at handover, as it is possible to perform realtime and accurate cell management at the cell detection and the cell monitoring.

Embodiment 6

In the description of the present embodiment, cycles for cell monitoring and cell detection are made shorter, regarding service information or spreading factor (SF, spreading ratio) information as an event.

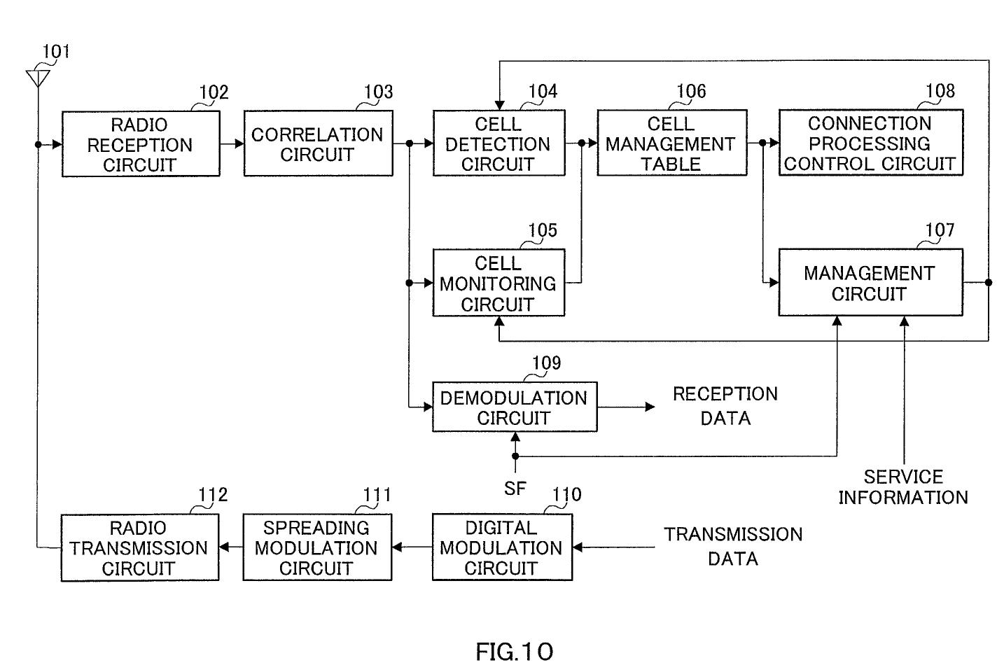

FIG. 10 is a block diagram showing a configuration of a piece of communication terminal apparatus according to an embodiment 6 of the present invention. In FIG. 10, parts similar to those in FIG. 1 are denoted by the same reference numerals as those in FIG. 1, and detailed description will be eliminated.

The communication terminal apparatus shown in FIG. 10 has a configuration where service information and spreading factor information are input to the management circuit 107, which sends a control signal for cell detection/cell monitoring to the cell detection circuit 104 and/or the cell monitoring circuit 105 according to the spreading factor information. Thereby, cell detection and cell monitoring are performed according to the changed cycle.

For example, information denoting that the signal is of a circuit switching type like a voice may be listed as service information. That is, the cycles for cell detection and cell monitoring are made shorter, as no intermittent interruption is required when the management circuit 107 receives information of a signal of a circuit switching type from the upper layer.

Then, it is judged by the threshold judgement whether the spreading factor is high or low when the management circuit 107 receives the spreading factor information. And, in the case of a low spreading factor, the cycles for cell detection and cell monitoring are made shorter, as the communication is easily disconnected.

The processing in the cell detection circuit 104 and the cell monitoring circuit 105 is performed in a similar manner to those of the above embodiment, and the description will be eliminated. Here, cell detection and cell monitoring are performed in a similar manner to those of the above embodiment 1.

As described above, the communication terminal apparatus according to the present embodiment saves electric power consumption as much as possible; and, makes calling time and waiting time longer by dynamic control of the frequencies for cell detection and cell monitoring according to the service information and the spreading factor information. And, handover operation may be performed in a reliable manner, and the communication quality may be secured at handover, as it is possible to perform realtime and accurate cell management at cell detection and cell monitoring.

Embodiment 7

In the description of the present embodiment, a BER (Bit Error Rate), a CRC (Cyclic Redundancy Check), and a BLER (Block Error Rate) are monitored, and cycles for cell monitoring and cell detection are made shorter, regarding the time, when the above value or values becomes or become lower than a thresholds, as an event.

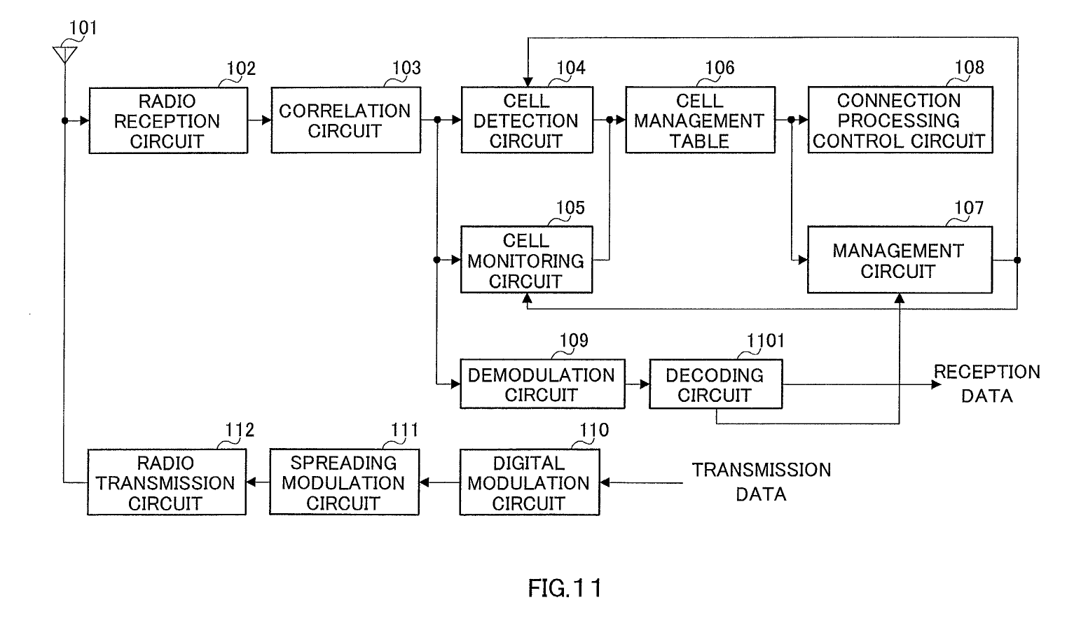

FIG. 11 is a block diagram showing a configuration of a piece of communication terminal apparatus according to an embodiment 7 of the present invention. In FIG. 11, parts similar to those in FIG. 1 are denoted by the same reference numerals as those in FIG. 1, and detailed description will be eliminated.

The communication terminal apparatus shown in FIG. 11 comprises a decoding circuit 1101 for decoding of a signal from a demodulation circuit 109. Here, the above decoding circuit 1101 is eliminated in the description of the above embodiments for simplification, though the above circuit is included in the communication terminal apparatus according to the above embodiments.

The above decoding circuit 1101 measures a BER, a CRC, and a BLER of a reception signal, and sends to the management circuit 107 an instruction for changing the cycle for cell detection/cell monitoring based on the above measuring results. The management circuit 107 sends at the changed cycle a control signal for cell detection/cell monitoring to the cell detection circuit 104 and/or the cell monitoring circuit 105. Thereby, cell detection and cell monitoring are performed at the changed cycle.

Subsequently, control of the cycle for cell detection/cell monitoring of a piece of communication terminal apparatus with the above configuration will be described.

In the correlation circuit 103, a correlation value is obtained by despreading processing of the reception signal. The above correlation value is sent to the cell detection circuit 104 and the cell monitoring circuit 105, and, at the same time, to the demodulation circuit 109.

The demodulation circuit 109 performs demodulation processing of the signal after despreading and sends the processed signal to the decoding circuit 1101, which decodes the signal after the above demodulation processing, and, at the same time, measures the BER, the CRC, and the BLER, for example, for the threshold judgement of the measured BER, CRC, and BLER. For example, when the above measurement results are equal to or larger than a predetermined threshold, a control signal for making the cycles for cell monitoring and cell detection shorter is sent to the management circuit 107, assuming that the quality of the reception signal is deteriorated. The management circuit 107 changes the cycles for cell detection and cell monitoring according to the above control signal and gives instructions for cell detection and cell monitoring at the changed cycle to the cell detection circuit 104 and the cell monitoring circuit 105.

The processing in the cell detection circuit 104 and the cell monitoring circuit 105 is performed in a similar manner to those of the above embodiment, and the description will be eliminated. Here, cell detection and cell monitoring are performed in a similar manner to those of the above embodiment 1.

As described above, the communication terminal apparatus according to the present embodiment saves electric power consumption as much as possible; and, makes calling time and waiting time longer by dynamic control of the frequencies for cell detection and cell monitoring according to the BER, the CRC, and the BLER after the decoding. And, handover operation may be performed in a reliable manner, and the communication quality may be secured at handover, as it is possible to perform realtime and accurate cell management at cell detection and cell monitoring.

Embodiment 8

In the description of the present embodiment, cycles for cell monitoring and cell detection are made shorter, regarding selection mode information as an event.

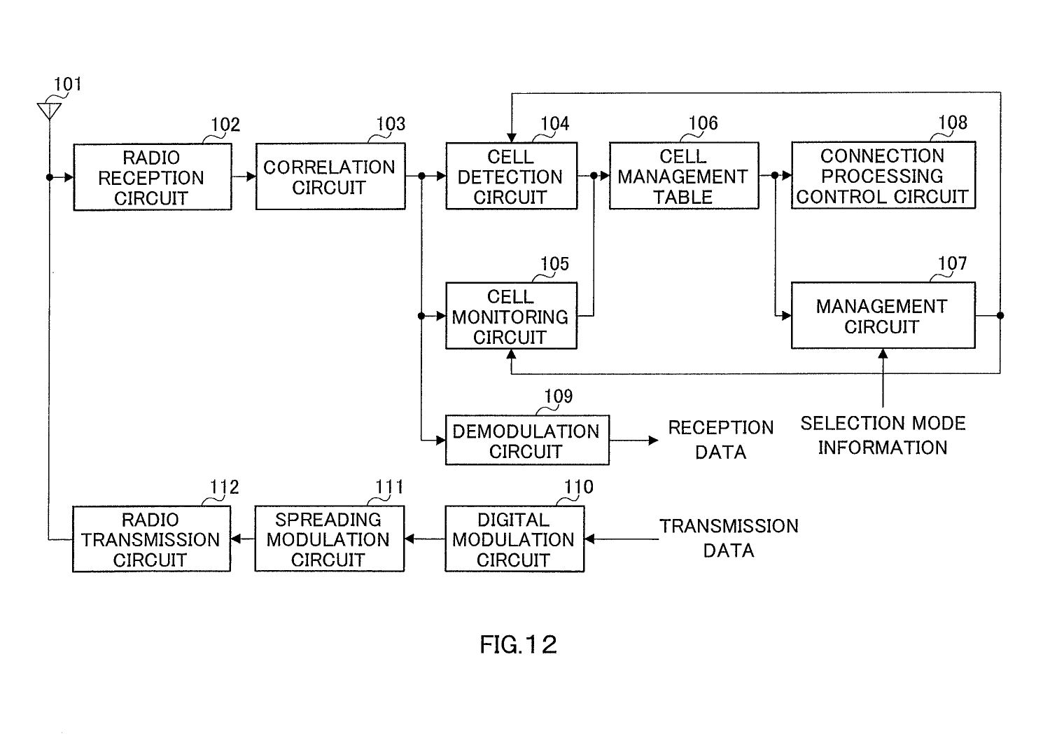

FIG. 12 is a block diagram showing a configuration of a piece of communication terminal apparatus according to an embodiment 8 of the present invention. In FIG. 12, parts similar to those in FIG. 1 are denoted by the same reference numerals as those in FIG. 1, and detailed description will be eliminated.

The communication terminal apparatus shown in FIG. 12 has a configuration where the selection mode information is input to the management circuit 107. The management circuit 107 sends a control signal for cell detection/cell monitoring to the cell monitoring circuit 105 and/or the cell detection circuit 104, according to the selection mode information. Thereby, cell detection/cell monitoring is performed at the changed cycle. The selection mode information is mode information by selection switching for low electric power consumption and high quality. Thereby, a user may select, as required, control of the cycles for cell detection and cell monitoring according to the event.

That is, cell detection and cell monitoring are controlled according to the event described in the above embodiment when the management circuit 107 receives a control signal for making the control according to the present invention ON with a selection switch for low electric power consumption. And, cell detection and cell monitoring are performed at usual cycles when there is received a control signal for making the control according to the present invention OFF with the selection switch in order for a user to obtain the high quality.

The processing in the cell detection circuit 104 and the cell monitoring circuit 105 is performed in a similar manner to those of the above embodiment, and the description will be eliminated. Here, cell detection and cell monitoring are performed in a similar manner to those of the above embodiment 1.

As described above, the communication terminal apparatus according to the present embodiment saves electric power consumption as much as possible; and, makes calling time and waiting time longer by dynamic control of the frequencies for cell detection and cell monitoring according to the selection mode information. And, handover operation may be performed in a reliable manner, and the communication quality may be secured at handover, as it is possible to perform realtime and accurate cell management at cell detection and cell monitoring.

Furthermore, when information on a cell candidate of another system (GSM (Global System for Mobile Communications), PDC (Personal Digital Cellular), PHS (Personal Handyphone System), and so on) is known, for example, in a dual mode terminal, the control according to the present invention may be performed by using the above information. That is, the frequencies for cell detection and cell monitoring of the present system may be made shorter using the cell candidate for the other system. This is effective for monitoring of other systems during transmission suspension in a compressed mode.

And, frequencies for cell detection and cell monitoring are made higher so that returning to the own service operator is performed as soon as possible, when the communication terminal is connected to other service operators and is in the boundary between areas of other service operators and the area of the own service operator, for example, when the communication terminal is in the boundary between an area of a service operator necessary for roaming and the area of the own service operator. Thereby, cheap call charges may be realized.

Suitable combinations among the above embodiments 1-8 may be executed.

The present invention is not limited to the above embodiments 1-8, and variations may be executed with modifications.

The communication terminal apparatus according to the present invention has a configuration comprising: a cell detection section for cell detection based on the results of correlation operation processing of a reception signal using a code to spread used for a transmission side; a cell monitoring section for cell monitoring using the results of the above correlation operation processing; a cell management table for management by classification into base station groups, based on the above results of cell detection and the above ones of cell monitoring; and a management section for control of the cycle for cell detection and/or cell monitoring according to an event.

The above configuration saves electric power consumption as much as possible; and, makes calling time and waiting time longer by dynamic control of the frequencies for cell detection and cell monitoring according to various kinds of events. And, handover operation may be performed in a reliable manner, and the communication quality may be secured at handover, as it is possible to perform realtime and accurate cell management at cell detection and cell monitoring.

The communication terminal apparatus according to the present invention has a configuration, wherein, in the above configuration, a management section controls the cycle for cell detection and/or cell monitoring, based on the levels of signals from base stations and on the number of base stations managed in the above cell management table.

The communication terminal apparatus according to the present invention has a configuration, wherein, in the above configuration, the above communication terminal apparatus comprises a monitoring section for monitoring the reception quality of each finger using the correlation operation processing results, and the above management section controls the cycle for cell detection/cell monitoring based on the above reception quality.

The communication terminal apparatus according to the present invention has a configuration, wherein, in the above configuration, the above communication terminal apparatus comprises a gain control section for control of the gain of the reception signal, and the above management section controls the cycle for cell detection/cell monitoring based on the above gain information of the reception signal.

The communication terminal apparatus according to the present invention has a configuration, wherein, in the above configuration, the above communication terminal apparatus comprises a measurement section for measurement of moving speed or altitude using the reception signal, and the above management section controls the cycle for cell detection/cell monitoring based on the above measurement results of moving speed or altitude.

The communication terminal apparatus according to the present invention has a configuration, wherein, in the above configuration, the management section controls the cycle for cell detection/cell monitoring based on at least one of pieces of information selected from a group comprising external electric power information, service information, spreading factor information, and error rate information.

The above configurations saves electric power consumption as much as possible; and, makes calling time and waiting time longer by control of the frequencies for cell detection and cell monitoring according to various kinds of events.

The base station apparatus according to the present invention is characterized in that the above base station apparatus performs radio communication with the above communication terminal apparatus. Thereby, handover operation may be performed without interruption and under securing predetermined communication quality.

The radio communication method according to the present invention comprises: a cell detection step for cell detection based on the results of correlation operation processing of a reception signal using a code to spread used for a transmission side; a cell monitoring step for cell monitoring using the above results of correlation operation processing; a management step for management by classification into base station groups, based on the above results of cell detection and the above ones of cell monitoring; and a control step for control of the cycle for cell detection and/or cell monitoring according to events.

The above method saves electric power consumption as much as possible; and, makes calling time and waiting time longer by dynamic control of the frequencies for cell detection and cell monitoring according to various kinds of events. And, hand over operation may be performed in a reliable manner, and the communication quality may be secured at handover, as it is possible to perform realtime and accurate cell management at cell detection and cell monitoring.

As described above, the communication terminal apparatus according to the present invention may save electric power consumption as much as possible; and, make calling time and waiting time longer, as the frequencies for cell detection and cell monitoring is dynamically controlled and reduced according to various kinds of factors (events). And, handover operation may be performed in a reliable manner, and the communication quality may be secured at handover, as it is possible to perform realtime and accurate cell management at cell detection and cell monitoring.

The present description is based upon the Japanese Patent Application No. HEI-11 (1999) -353672 filed on Dec. 13, 1999, the entire contents of which are incorporated herein by reference.

Industrial Applicability

The present invention may be applicable to a piece of communication terminal apparatus and a method for radio communication.

1. A piece of communication terminal apparatus, comprising:
cell detection means for cell detection based on the results of correlation operation processing of a reception signal using a code for spreading used for a transmission side;
cell monitoring means for cell monitoring using the results of said correlation operation processing;
a cell management table for management by classification into base station groups, based on said results of cell detection and said ones of cell monitoring; and
management means for control of the cycle for cell detection and/or cell monitoring according to an event.

2. A piece of communication terminal apparatus according to claim 1, wherein,
said management means controls the cycle for cell detection and/or cell monitoring, based on the levels of signals from base stations and on the number of said base stations managed in said cell management table.

3. A piece of communication terminal apparatus according to claim 1, comprising
monitoring means for monitoring the reception quality of each finger using said correlation operation processing results, wherein
said management means controls the cycle for cell detection/cell monitoring based on said reception quality.

4. A piece of communication terminal apparatus according to claim 1, comprising
gain control means for control of the gain of the reception signal, wherein
said management means controls the cycle for cell detection/cell monitoring based on gain information of the reception signal.

5. A piece of communication terminal apparatus according to claim 1, comprising
measurement means for measurement of moving speed or altitude using the reception signal, wherein said management means controls the cycle for cell detection/cell monitoring based on said measurement results of moving speed or altitude.

6. A piece of communication terminal apparatus according to claim 1, wherein
said management means controls the cycle for cell detection/cell monitoring based on at least one of pieces of information selected from a group comprising external electric power information, service information, spreading factor information, and error rate information.

7. A base station for radio communication with a piece of communication terminal apparatus, wherein
said communication terminal apparatus comprises:
cell detection means for cell detection based on the results of correlation operation processing of a reception signal using a code for spreading used for a transmission side;
cell monitoring means for cell monitoring using the results of said correlation operation processing;
cell management table for management by classification into base station groups, based on said results of cell detection and said ones of cell monitoring; and
management means for control of the cycle for cell detection and/or cell monitoring according to an event.

8. A radio communication method according to the present invention comprises:
a cell detection step for cell detection based on the results of correlation operation processing of a reception signal using a code for spreading used for a transmission side;
a cell monitoring step for cell monitoring using said results of correlation operation processing;
a management step for management by classification into base station groups, based on said results of cell detection and said ones of cell monitoring; and
a control step for control of the cycle for cell detection and/or cell monitoring according to events.
